(19) United States
(12) Patent Application Publication
(10) Pub. No.: US 2026/0354371 A1
(43) Pub. Date: Nov. 12, 2026

(54) METHOD AND APPARATUS FOR ULTRA-RAPID PREPARATION OF CORNEAS FOR VITRIFICATION

(71) Applicant: 21ST CENTURY MEDICINE, INC., Fontana, CA (US)

(72) Inventors: Xian GE, Rancho Cucamonga, CA (US); Jun WU, Rancho Cucamonga, CA (US); Brian WOWK, Corona, CA (US); Gregory M. FAHY, Corona, CA (US)

(73) Assignee: 21ST CENTURY MEDICINE, INC., Fontana, CA (US)

(21) Appl. No.: 18/997,012

(22) PCT Filed: Jul. 18, 2023
(86) PCT No.: PCT/US2023/070435

§ 371 Date: Jan. 18, 2025

Related U.S. Application Data
(60) Provisional application No. 63/390,074, filed on Jul. 18, 2022.

(51) Int. Cl. A01N 1/125; A01N 1/142; A01N 1/162

(52) U.S. Cl. CPC A01N 1/125; A01N 1/142; A01N 1/162

(57) ABSTRACT

A method is disclosed for handling, treating, and storing corneas that enables vitrification in air and/or liquid nitrogen vapor and rewarming without appreciable cell loss, cell death, or functional impairment after transplantation compared to untreated control corneas. The method employs extreme cornea shrinkage through osmotic disequilibrium and corneal dehydration, enabling cryoprotectant toxicity to be avoided despite prolonged exposure to peak (vitrifiable) concentrations of cryoprotectant above 0 °C and cryoprotectant washout without osmotic buffering. The cornea apparatus enables ideal handling and storage and air cooling inside or outside the container used for storage.

### CROSS-REFERENCE TO RELATED APPLICATIONS

The invention claims the benefit of priority to U.S. Provisional A application No. 63/390,074, which was filed on Jul. 18, 2023, which is incorporated herein by reference in its entirety.

### FIELD OF THE INVENTION

This invention relates to the preservation of human, animal, and bio-artificialcorneas by vitrification, including methods and apparatus for same.

### BACKGROUND OF THE INVENTION

### The Need for Long Term Cornea Preservation

Vitrification has the potential to positively affect most of the corneas transplanted annually in the United States and to enable the export of tens of thousands of natural corneas and unlimited numbers of bioartificial corneas from the United States to countries where high quality corneas are needed.

Worldwide, there are 10 million cases of corneal blindness that could be relieved by corneal transplantation (Kingsley 2002, Anonymous 2003, McGinn 2003), but only 100,000transplants are performed each year (Kingsley 2002, Anonymous 2003). There are many countries in which cultural and religious strictures prevent cornea donation, but in which sufficient medical sophistication and wealth exists to permit transplantation of imported corneas if they could be obtained in transplantable condition, prominent examples being Taiwan (Hu, Tsai et al. 1999), Japan (Goto, Fukuhara et al. 1999), and India (Anonymous 2003). In India alone, there were, as of 2002, 1.3 million blind people whose sight could be restored with a cornea transplant (Anonymous 2003), with at least another 40,000 cases being added every year (Anonymous 2003, Anonymous 2003), but the local supply of donated eyes was only 15,000-18,000 per year (Anonymous 2003). In the US, there were 1,367,460 deaths in the over-75 age range in 2001 (Anonymous 2003), of which about 34% could donate corneas for penetrating keratoplasties (Probst, Halfaker et al. 1997), and 1,048,965 deaths of individuals under 75 (Anonymous 2003), of which perhaps 71% could provide usable corneas (Armitage and Easty 1997), indicating that the number of natural corneas potentially available exceeds the domestic demand and could support exportation if they could be preserved long enough for that to be feasible.

All corneas in the United States are stored at 4 °C (Bourne 2001). Corneas stored for just 4 days or so lose endothelial cell density (ECD, which is the number of corneal endothelial cells per unit area of corneal endothelial surface) to the point of being declined for transplantation, whereas ECD will not decline in vitrified corneas. The same deterioration with refrigerated but not cryopreserved corneas clearly limits the export of corneas to remote reaches of the globe as well (Goto, Fukuhara et al. 1999, Hu, Tsai et al. 1999, Hollins 2000, McGinn 2003). For example, despite going to great lengths to ensure rapid international delivery of exported corneas, corneas exported from the United States to Taipei, Taiwan looked “markedly different” from the photographs taken in the US upon arrival in Taipei, an estimated 590 endothelial cells/mm2 were lost in transit (Hu, Tsai et al. 1999), and many were too edematous to transplant, failed immediately after transplantation, or showed a 72% loss of ECD after 4 years post-transplant, which borders on failure. Clearly, better methods of stabilizing corneas are needed.

In Europe, corneas are maintained in an “organ culture” system at 31-37 °C for up to about 5 weeks (Armitage and Easty 1997, Bourne 2001, Thuret, Chiquet et al. 2003), although only 57% are suitable for transplantation after 4 weeks, and only 53% retain an “excellent” rating after 2 weeks or less [9]. According to Redmond et al. (Redmond, Armitage et al. 1992), “immediately after transplantation, organ-cultured corneas were thicker and more opalescent than corneas that had been stored at 4 °C [and] grafts cleared relatively slowly, taking 3-4 weeks to achieve good transparency.” During storage in culture, corneas slowly swell and must be “deswollen” in a concentrated polymer solution such as dextran T500 for about two days before they are suitable for transplantation (Thuret, Chiquet et al. 2003). This situation complicates the long distance export of cultured corneas, because flabby corneas might be expected to be even more sensitive to damage in transit than corneas stored in Optisol-GS at 4 °C, but sending corneas in deswelling medium would be untenable unless the cornea can arrive at its destination and be transplanted within 2-3 days of being sent because holding in dextran for too long is deleterious because of irreversible uptake of dextran (or any other deswelling agent) by the cornea. Another problem with shipping cultured corneas is the difficulty of maintaining cornea temperature en route. Clearly, the present inability to arrest damage during cornea storage at 4 °C or above leads to wastage, extra costs, reduced transplant quality, some late graft failure, and poor opportunities for intercontinental cornea sharing.

Despite the “immunological privilege” of the cornea (Niederkorn 2003), rejection was the cause of 28% of all graft failures in a low-risk population by year 10 (relative risk, 17.3, p<0.001) (Ing, Ing et al. 1998). Clearly, vitrification would enable the gradual accumulation of a bank of different HLA and ABO typed corneas that would allow prospective matching to be undertaken to reduce rejection.

The Commercial Incentive for Developing Long-term Cornea Preservation Methods

The potential commercial incentive for developing successful clinical corneal banking is considerable. Circa 2000, corneas available for research cost about $2000 for a fresh, transplant grade cornea, $600 for a cornea less than 4 days old, $350 for a cornea less than six days old, and $200 for a cornea more than six days old. Corneas that are exported for transplantation because of dwindling shelf life were commonly marked down to $500 (Campbell 2000). Immediate vitrification of corneas at their time of arrival at eye banks could have therefore provided a $1400-$1800 value per cornea for many or most corneas in 2000 dollars. Supposing a licensing fee of $800 per cornea, application to the 33,000 corneas used domestically in the United States and the at least 43,000 corneas that could be exported with full use of older cornea donors combined with $400/cornea for another 100,000 exported vitrified bioartificial corneas to meet 1% of the estimated overseas backlog each year would yield annual revenues of over $100 million.

Given the need for better corneal preservation and the financial incentives to develop it, the lack of a commercially successful method for long term cornea banking despite over 70 years of effort to date (see below) is clearly due to a lack of adequate art and is not due to a lack of adequate incentive. This provides prima facie evidence that the process of the current invention, which surprisingly supplies a solution to the long-standing problem of adequate corneal cryopreservation, cannot be obvious over the prior art.

### Prior Art Efforts to Cryopreserve Corneas

The cryopreservation of human corneas has a history reaching back at least to 1944, when Weiss and Taylor attempted the freeze-drying and transplantation of rat corneas, claiming persistent transparency after grafting (Weiss and Taylor 1944). Henaff also claimed success after freeze-drying dog corneas and transplanting them into human recipients (Henaff 1960), but freeze-drying is not considered a viable approach today.

The first attempt to preserve corneas by slow freezing with a cryoprotectant was reported in 1954 by Rob and Eastcott (Rob and Eastcott 1954), who froze corneas to the temperature of dry ice (−79 °C) using 15% glycerol and observed transparency lasting as long as six weeks after thawing and transplantation. Over time, innumerable additional studies on corneal cryopreservation by freezing were published. The most popular of these was the method developed by Capella, Kaufman, and Robbins in 1965 (Capella, Kaufman et al. 1965) (usually called the Kaufman-Capella or K-C method), which involved freezing at 2-3°C/min in a combination of dimethyl sulfoxide and sucrose to −80 °C followed by transfer into liquid nitrogen. Corneas cryopreserved by the K-C method and by other clinical freezing methods are usually able to remain clear postoperatively after cryopreservation, but up to 15% of such corneas fail immediately upon transplantation (Brunette, Le Francois et al. 2001), and the 10-year graft survival rate using the K-C method is as low as 47% (Brunette, Le Francois et al. 2001) versus 78% for non-cryopreserved grafts in one study (Ing, Ing et al. 1998). Freezing inevitably results in variable degrees of corneal endothelial cell loss before and after transplantation (Van Horn and Schultz 1974, Ehlers, Sperling et al. 1982, Ehlers and Sperling 1983, Taylor 1986, Brunette, Le Francois et al. 2001) even when the time between death and freezing is confined to 8 hours or less (Van Horn and Schultz 1974, Ehlers, Sperling et al. 1982, Ehlers and Sperling 1983, Brunette, Le Francois et al. 2001). Any cell loss is important because intrinsic graft failure (failure to maintain clarity in the absence of a recent rejection episode) is related to endothelial cell loss (Ing, Ing et al. 1998, Bourne 2001, Armitage, Dick et al. 2003, Thuret, Chiquet et al. 2003). The authors of a 2001 retrospective study on the outcome of transplantation of corneas cryopreserved with the K-C method said “we do not recommend cryopreservation of corneas for elective surgery” (Brunette, Le Francois et al. 2001) due to the high initial failure rate of cryopreserved corneas. Canals et al. concluded: “until this high variability can be drastically reduced, systematic corneal cryopreservation in eye banking remains unattainable” (Canals, Costa et al. 1996).

The best prior art attempts to develop cornea vitrification methods have all fallen short (Armitage 1989, Brunette, Nelson et al. 1989, Rich and Armitage 1991, Rich and Armitage 1991, Bourne and Nelson 1994, Bourne, Shearer et al. 1994, Armitage, Hall et al. 2002). The fundamental problem with all of these efforts is exemplified by the following summary by Bourne and Nelson of their specific findings: “immersion of the human corneas for 25 min in each of the four graded solutions at 0 degrees C was required for sufficient penetration of the cryoprotectant to allow total corneal vitrification and rewarming without ice formation. This prolonged exposure to modified VS41A caused unacceptable damage to the corneal endothelium, however. Successful vitrification of human corneas with this solution will require a safe method for obtaining corneal equilibration with the cryoprotectant” (Bourne and Nelson 1994).

In 2002, Armitage reported that rabbit corneas vitrified and rewarmed in a solution containing 50% v/v (6.8M) 1,2-propanediol, 0.25 M sucrose, 6% w/v polyethylene glycol, and 2.5% w/v chondroitin sulfate swelled during the first 3 hours of in vitro perfusion, but were able to actively limit their hydration thereafter to attain essentially stable thickness values of about 0.6 mm vs. the control value of about 0.37 mm (Armitage, Hall et al. 2002). After two hours of thinning in 5% dextran, alizarin red and trypan blue staining were somewhat abnormal, but there was no reduction in endothelial cell density. In addition, a single human cornea vitrified and rewarmed using the same method and thinned with dextran showed normal cell density and normal alizarin staining but with occasional trypan blue staining of isolated cells (Armitage, Hall et al. 2002). Although these results are encouraging and show potential, the results fall short of clinical utility because the evidence for human corneas was quite limited (n=1) and did not include any long-term studies of corneal function after transplantation, and the method employed a 12-step, 2.5-hr cryoprotectant loading and unloading procedure that necessitated 7 different temperature-controlled baths. Given how difficult it would be to implement this process in an eye bank, the author himself later deemed his method impractical (Routledge and Armitage 2003).

Two patents have claimed methods specifically for whole cornea cryopreservation by vitrification.

Linner and Goosey claimed apparatus and methods for “cryofixation in less than one second” (col. 2, lines 26-27) by means of ultra-rapid cooling without cryoprotective agents (Linner and Goosey 1986). The allegedly (but almost certainly not actually) “vitrified” cornea is then dehydrated by sublimation of water near −130 °C under high vacuum to achieve the benefits of freeze-drying without the formation of ice crystals. No documentation of long-term function after transplantation or of any in vitro functional or viability testing was provided, and there has been no adoption of this method by ocular surgeons since it was introduced in this 1986 patent to the knowledge of the present inventors. The method bears no resemblance in concept or in practice to the presently claimed invention.

In 1996, Wilkins and Watson, of Organogenesis, Inc., patented a method for cryopreservation of living skin equivalents (LSEs) with agitation and speculated that the method would also be applicable to corneas (Wilkins and Watson 1996). The method comprises a non-isothermal (col. 5, lines 4, 13-20, and 25) process of immersing the specimen “in cryoprotectant solutions for a period of time . . . sufficient to permit the equilibration of the cells with the cryoprotectant” (col. 4, lines 66-67 to col. 5, line 1), wherein the “cryoprotectant solution is agitated for a time period sufficient to allow the effective permeation of the cryoprotectant into” the tissue (col. 5, lines 31-33). Warming is then carried out “in about 1 to 3 seconds” (col. 6, line 6) and the “cryoprotectant solution is removed . . . within about 15 minutes after thawing” (col. 6, lines 14-15). However, the invention as it pertained to corneas was entirely theoretical in nature: no experiments were actually performed on any corneas or artificial corneas, all experimental work being confined to LSEs. As will be seen in the Description of the Invention below, this method does not anticipate the present invention, and as is clear from the above discussion, the invention of Wilkins and Watson has not been clinically successful for corneas.

A third patent entitled “Corneal vitrification, methods and devices to produce corneal vitrification and methods of use thereof” (Serdarevic, Berry et al. 2015) is not about corneal cryopreservation by vitrification. This patent is instead directed for the formation of a glassy state in corneas in situ using optical means for the purpose of improving vision. In this process, the cornea remains warm at all times, and cryoprotective agents are never used to induce the vitreous state by cooling to temperatures below −100 °C.

To date, bioartificial cornea cryopreservation has not been reported to our knowledge. However, our method will also preserve bioartificial corneas similarly to natural corneas.

Prior art exists for preserving corneal endothelial cells not attached to an actual cornea and for general tissue vitrification, but it is not helpful because a) it is impossible to predict the outcomes of whole cornea preservation protocols using this information (since attached cells will respond differently than unattached cells; the cornea consists of three organized structures and not unattached cells or even isolated cell layers alone; and it is well known in the art that methods that work for isolated cells or for one tissue type frequently and generally do not work for cell assemblages or for a completely different tissue type), and b) this information has not to date been enabling for the creation of useful methods of whole cornea vitrification despite being available in most cases for a decade or more.

To conclude, the present art can be summarized by quoting from the most recent review of corneal cryopreservation presently available (from 2021), which stated: “cryopreservation, as of now, is recommended only in emergencies for tectonic keratoplasty” (Rodriguez-Fernandez, Alvarez-Portela et al. 2021). Therefore, the need for a suitable method of corneal cryopreservation has not been satisfied in the prior art and, given strong incentives to overcome present deficiencies, successful art cannot be obvious over the prior art.

### BRIEF SUMMARY OF THE INVENTION

In one aspect, the present invention is a method for achieving nearly damage-free preservation of animal, human, and bio-artificial corneas by vitrification not by achieving cryoprotectant and osmotic equilibration of the cornea as attempted and as called for by all prior art methods but by the opposite approach of deliberately inducing extreme non-equilibration corneal dehydration to foster vitrification at very low cooling rates, prevent devitrification at very low warming rates, and prevent cryoprotectant toxicity. The invention method is preferably carried out using specially designed equipment to enable appropriate handling, storage, and rewarming of the cornea while preventing corneal mechanical damage. The invention provides conditions of cryoprotectant exposure that dramatically increase the glass transition temperature of the cornea by means of extreme dehydration and somehow surprisingly block cryoprotectant toxicity during prolonged exposure above 0 °C. The invention includes rapid introduction and washout of highly vitrifiable concentrations of cryoprotectants of elevated theoretical tonicity under practical isothermal conditions that are readily achievable in ordinary eye banks.

The present invention, in addition to enabling truly elective timing of the use of both locally-procured and globally-shared corneas, eliminating corneal deterioration with time, eliminating seasonal fluctuations in the availability of corneas for transplantation, ensuring availability of corneas on an emergency basis, reducing logistic costs, and eliminating corneal outdating, will also have the potential to reduce rejection as a cause of graft failure by allowing tissue matching between donor and recipient during the cornea storage period.

In one embodiment, the disclosure provides a method for cryopreserving a human, animal, or bioartificial cornea, comprising:

Placing the cornea in a cryoprotectant solution and increasing the cryoprotectant concentration in the solution surrounding the cornea from 0% of the target cryoprotectant concentration for vitrification to 100% of the target cryoprotectant concentration for vitrification in 0-25 min, and most preferably in <20 min, and either continuously or in 1-3 steps, and more preferably in 5 -15 min or still more preferably in 8-12 min and preferably continuously or in 1-3 steps, and thereafter

Maintaining the cornea in a solution containing said 100% of the target cryoprotectant concentration for vitrification for 9-30 min before vitrification, and most preferably for 10-25 min before vitrification, and thereafter

Vitrifying the cornea, storing it for a desired time, and then rewarming it, and then Reducing the concentration of the said cryoprotectant solution surrounding said cornea from 100% of the said target concentration for vitrification to 0% of the said target concentration for vitrification in 0-25 min, and preferably in <20 min, and either continuously or in 1-3 steps, and most preferably in 0-15 min and continuously or in 1-3 steps, wherein The method is preferably carried out under nominally isothermal conditions between 0 and 10°, and wherein

The cornea may be cooled and warmed at rates as low as 5 +C/min or less between 0 and −100 °C without ice formation, and wherein

A different carrier solution may be used for said reducing of the concentration of said cryoprotectant than for said increasing the concentration of the said cryoprotectant, and wherein

The cornea is either manipulated during the method by means of a manipulation means comprising a ring and a suspension means for the ring or the cornea is maintained immobile in the ring of the manipulation means while the concentration of cryoprotectant in contact with the cornea is changed continuously without manipulating the cornea.

Another embodiment of the invention comprises a manipulation means for the cornea, comprising a ring for supporting the cornea and a means for positioning said ring above the floor of any container in which the cornea may be placed so as to prevent contact between the cornea and said container floor, wherein
said means for positioning said ring above the floor of any container in which the cornea may be placed may consist of a stand extending from the ring downwards to the floor of the container or
said means for positioning said ring above the floor of any container in which the cornea may be placed may consist of a handle attached to said ring that can be grasped and held manually or by means of a positioning device, wherein
said means for positioning said ring above the floor of any container in which the cornea may be placed may comprise both a stand and a handle to facilitate movement of the ring and the stand and/or
said means for said positioning of said ring may comprise a vertical member extending upward from the ring and attaching to a movable lid for said container in which the cornea may be placed, wherein said vertical member positions the cornea above the floor of said container without contact between the cornea and said container floor when said movable lid for said container is used to close said container, and
said means for said positioning of said ring may comprise in addition to said vertical member extending upward from the ring and attaching to a movable lid for said container in which the cornea may be placed a graspable handle located above the lid to further facilitate movement of the lid, vertical member, ring, and cornea within the ring.

### BRIEF DESCRIPTION OF THE DRAWINGS

The patent or application file contains at least one drawing preferably executed in color. Copies of this patent or patent application publication with color drawings will be provided by the U.S. Patent and Trademark Office upon request and payment of the necessary fee

FIG. 1 illustrates one embodiment of apparatus useful for carrying out the process of the invention.

FIG. 2 demonstrates nearly 100% cell survival (A) and 100% retention of cornea endothelial cells within the endothelial cell layer of the cornea (B) after vitrification under conditions of extreme corneal dehydration (two-step loading to 9.45M cryoprotectant) followed by rewarming and VS washout.

FIG. 3 compares two cryoprotectant addition and removal protocols effective in the invention.

FIG. 4 shows survival of vitrified/rewarmed/xenografted human corneas based on gross and microscopic examination.

FIG. 5 demonstrates elevated glass transition temperatures and immunity to ice formation in human corneas during rewarming at 5 °C/min after previous vitrification according to protocol 2.

FIG. 6 shows typical cooling and warming curves, which greatly exceed the rates needed to prevent ice formation.

FIG. 7 describes the persistence of ECD in control and vitrified human corneas over 4 months following transplantation into monkeys.

FIG. 8 demonstrates the ability of vitrified human corneas to thin over time after transplantation into monkeys to the same degree and at the same rate as the best control cornea.

FIG. 9 displays normal human corneal morphology based on both light and scanning electron microscopy 4 months after transplantation into monkeys.

### DETAILED DESCRIPTION OF THE INVENTION

In a preferred embodiment, the invention comprises a method for cryopreserving a human, animal, or bioartificial cornea by inducing a state of extreme dehydration of the said cornea by immersion of the said cornea in a concentrated cryoprotectant solution for a time long enough to induce major exosmosis of water from the cornea but insufficient to allow corneal equilibration with the cryoprotectant solution. “Extreme” in this context denotes dehydration sufficient to raise the TG of the cornea by at least 7 °C relative to the TG of the vitrification solution employed to vitrify the cornea, reduce the change in heat capacity at the glass transition by at least 40% relative to the change in heat capacity at the glass transition of the vitrification solution employed to vitrify the cornea, and reduce the critical cooling and warming rate of the cornea between 0 °C and −100 °C to 5 °C/min or less. Specific means for achieving these endpoints, which can be reliably applied without the necessity of measuring the achieved endpoints, are described in the Examples that follow.

In one embodiment of the invention, M22 and solutions comparable in composition and concentration to M22 (Fahy, Wowk et al. 2004, Fahy 2005) are used and are preferred for use in the invention. However, no specific cryoprotectant solutions are required to practice the method of the invention as long as any sufficiently non-toxic cryoprotectant solution is introduced according to the methods of the invention as described herein. In essence, the process comprises a loading process in which the cryoprotectant concentration is increased from 0% VS to 100% VS in preferably less than 20 min and either continuously or in less than 4 steps, and preferably when said increase occurs over 8-12 min and either continuously or in 2-3 steps. The process further comprises an unloading process in which the VS is removed in preferably less than 20 min and either continuously or in 2-3 steps, and preferably in 8-15 min and continuously or in 2-3 steps. The process is also carried out preferably under nominally isothermal conditions between 0 and 10 °C. The method further comprises exposure of the cornea, after the process of increasing the concentration to 100% VS, to 100% VS for 10-30 min before vitrification, and most preferably for 20-25 min before vitrification. The Examples and other guidance provided herein will enable one of skill in the art to practice the invention as claimed in many different specific embodiments.

One preferred embodiment of the invention uses LM5 or a similar carrier optimized for vitrification as the carrier solution for addition of cryoprotective agent (Fahy, Wowk et al. 2004, Fahy 2005) and CPTES plus 2.5% chondroitin sulfate (Taylor and Hunt 1989) or another carrier optimized for stabilizing cornea viability as the carrier used for washout of the CPA. Solutions optimized to promote vitrification or for use on organs are not necessarily ideal for corneas, so reducing the exposure time to LM5 or other carriers not optimized for use on corneas is considered beneficial although it is optional in the invention.

The method of the invention is best carried out using a device consisting of at least one ring for supporting the cornea and one means for positioning said ring above the floor of any container in which the cornea may be placed so as to prevent contact between the cornea and said container floor.

Said means for positioning said ring may consist of a stand extending from the ring downwards to the floor of the container.

Said means for positioning said ring may alternatively consist of a handle attached to said ring that can be grasped and held manually or by means of a positioning device.

Said means for positioning said ring may alternatively consist of a combination of a stand and a handle to facilitate movement of the ring and the stand.

Said means for positioning said ring may alternatively comprise a vertical member extending upward from the ring and attaching to a movable lid for said container in which the cornea may be placed, wherein said vertical member positions the cornea above the floor of said container without contact between the cornea and said container floor when said movable lid for said container is used to close said container.

Said means for positioning said ring may alternatively comprise a vertical member extending upward from the ring and attaching to a movable lid for said container in which the cornea may be placed, wherein said vertical member positions the cornea above the floor of said container without contact between the cornea and said container floor when said movable lid for said container is used to close said container, wherein said movable lid includes as well a graspable handle located above the lid to further facilitate movement of the lid, vertical member, ring, and cornea within the ring.

The method of the invention is also best carried out using either a series of containers bearing different concentrations of cryoprotectant into which the cornea on the said positioning ring is successively transferred or using continuous cryoprotectant concentration gradients provided by gradient forming means, wherein the cornea is positioned in a bath whose concentration is continuously changed by said gradient forming means.

The method of the invention is also optionally carried out by transferring the cornea on its ring into a pre-cooled storage container located in a cold environment, which may be an environment whose temperature is below the TG of the cornea vitrification solution, and thereby vitrifying the cornea in a gaseous environment wherein the cooling rate may be as low as less than 5 °C/min between 0 °C and −100 °C, and sealing said pre-cooled storage container.

Alternatively, the invention may be carried out by transferring the cornea on its ring into a cold environment, which may be an environment whose temperature is below the TG of the cornea vitrification solution, thereby vitrifying the cornea in a gaseous environment, wherein the cooling rate may be as low as less than 5 °C/min between 0 °C and −100 °C, and thereafter transferring the cornea on its ring into a pre-cooled storage container and sealing said pre-cooled storage container.

The following descriptions of the details of the invention are meant to be illustrative rather than exhaustive or limiting. It will be apparent to one of skill in the art that variations of the methods, solutions, and apparatus as specifically described herein that do not depart from the spirit, scope, and meaning of the invention as described are merely different embodiments of the same invention and fall within the scope of the invention as claimed. For example, introduction of immaterial temperature changes merely for the purpose of attempting to circumvent the invention on the grounds that the invention is preferably an isothermal process would result in a process that would still fall within the spirit and scope of the invention. The components of the invention are described by means of the following Examples. The invention itself comprises the totality of these examples and of appropriate variations thereof, e.g., as described above.

### Definitions

It is first useful to ensure accurate understanding of the invention by defining certain terms as used herein.

“Cryoprotectants,” also known as “cryoprotective agents” or “CPAs,” are molecules that reduce or prevent freezing injury by reducing or preventing the formation of ice below 0 °C. The nature and properties of cryoprotectants are well known in the art (Meryman 1971, Fuller 2004, Fahy 2005, Abazari, Meimetis et al. 2015, Elliott, Wang et al. 2017). They consist of penetrating cryoprotectants (pCPAs) and non-penetrating cryoprotectants (npCPAs). The use of pCPAs and npCPAs in the invention is described in more detail below. The term “cryoprotectant” or “CPA” as used herein may refer to one or to multiple cryoprotectants, and to either pCPA alone or to a mixture of pCPA and npCPA. For example, adding or washing out the solution known as M22 (Fahy, Wowk et al. 2004), which is a preferred solution for use in the present invention, or related solutions (Fahy 2005) can be referred to as adding or washing out “the cryoprotectant” or “the CPA” even though these solutions are composed of multiple pCPAs and multiple npCPAs.

A “carrier” solution is the component of a cryoprotectant solution other than the cryoprotectant (Fahy 2005, Fahy and Wowk 2021). It consists of solutes necessary for the support of cellular viability and health in the presence or absence of a cryoprotectant. A non-exhaustive list of carrier solutions used in past studies includes LM5 (Fahy 2005), Eurocollins solution (Khirabadi and Fahy 1994), CPTES and CPTES plus chondroitin sulfate (Taylor and Hunt 1989), culture media, organ preservation solutions, and simple salt solutions.

“TG” is the glass transition temperature, which marks the temperature range for the transition from the liquid state to the glassy state on cooling or from the glassy state to the liquid state on warming (Fahy and Wowk 2021).

“Vitrification” is the conversion of a liquid to a solid without crystallization. The solid formed by vitrification is known as a glass and is structurally similar to a liquid but virtually lacks the translational molecular motions of a liquid. “Vitrification” is also a method of cryopreservation without ice formation.

“Devitrification” is the formation of ice in a previously vitrified system upon rewarming. It is not the reverse of vitrification. The reverse of vitrification is liquification.

A “vitrification solution” or “VS” is a cryoprotectant solution that is sufficiently concentrated to preclude ice formation during cooling to TG at the cooling rate employed to preserve the living system that is to be preserved (Fahy, MacFarlane et al. 1984, Fahy and Wowk 2021).

“Equilibration” or “equilibrium” is achieved when diffusion stops owing to the leveling of concentration gradients between the cornea and its environment.

“Osmotic equilibrium” is considered to have been reached when the cornea is restored to its original volume by equilibration of the cryoprotectant concentration between the cornea and the cryoprotectant medium to which it has been exposed after previous osmotic volume changes of the cornea induced by changing the pCPA concentration of the medium surrounding the cornea. If one or more npCPAs is present in said medium surrounding the cornea, then osmotic equilibrium is considered to have been reached when the cornea reaches a stable reduced equilibrium volume induced by exposure to said npCPA, said stable reduced volume being within 20% of Vsr=(Vi−b)×πi/πf+b, where Vsr is the stable reduced volume of the cornea, Vi is the volume of the cornea in ordinary isotonic medium and in the absence of cryoprotectant, b is the non-osmotic volume of the cornea (a constant), πi is the osmolality of the isotonic carrier solution not containing the npCPA, and πf is the osmolality of the CPA carrier solution plus the osmolality of the npCPA.

“Exosmosis” is the movement of water out of the cornea due to immersion of the cornea in a solution having an osmolality higher than the osmolality of the cornea prior to the time of immersion in said solution.

“Rewarming” is the return of the temperature of a vitrified system to a temperature near 0 °C or above.

Unless specifically stated or obvious from context, as used herein, the terms “a”, “an”, and “the” are understood to be singular or plural.

Furthermore, “and/or” where used herein is to be taken as specific disclosure of each of the two specified features or components with or without the other. Thus, the term “and/or” as used in a phrase such as “A and/or B” herein is intended to include “A and B,” “A or B,” “A,” (alone) and “B” (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

Any compositions, apparatus, systems or methods provided herein can be combined with one or more of any of the other compositions, apparatus, systems or methods provided herein.

In this disclosure, “comprises,” “comprising,” “containing” and “having” and the like can have the meaning ascribed to them in U.S. Patent law and can mean “includes,” “including,” and the like. The terms “consisting essentially of” or “consists essentially” of likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

### EXAMPLE 1: HUMAN CORNEA HANDLING APPARATUS

The inventors first observed that corneas tend to be damaged if not handled correctly. Superfusion systems such as those previously used at the Bourne lab at the Mayo Clinic (Brunette, Nelson et al. 1989, Bourne, Shearer et al. 1994) hold corneas in a secure fashion but cannot be used to vitrify and rewarm corneas due to their large mass. In the prior art, corneas have simply been placed on the floors of small containers, endothelial side up, presumably using forceps, to transfer them from one cryoprotectant solution to another, or to other environments. However, we found that this technique causes epithelial damage due to contact between the epithelium and the container floor.

The inventors were able to prevent this damage initially by supporting and transferring the corneas, endothelial side up, through a series of 10 ml solutions at 4 °C on a square plastic O-ring that suspended the bottom of the cornea above the floor of the container when the O-ring was placed on the floor of the container. This was helpful for introducing and removing cryoprotectant but did not allow facile vitrification and rewarming and did not allow for free diffusion of cryoprotectant around the epithelial surface of the cornea.

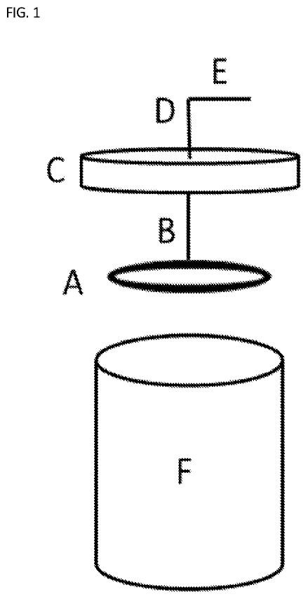

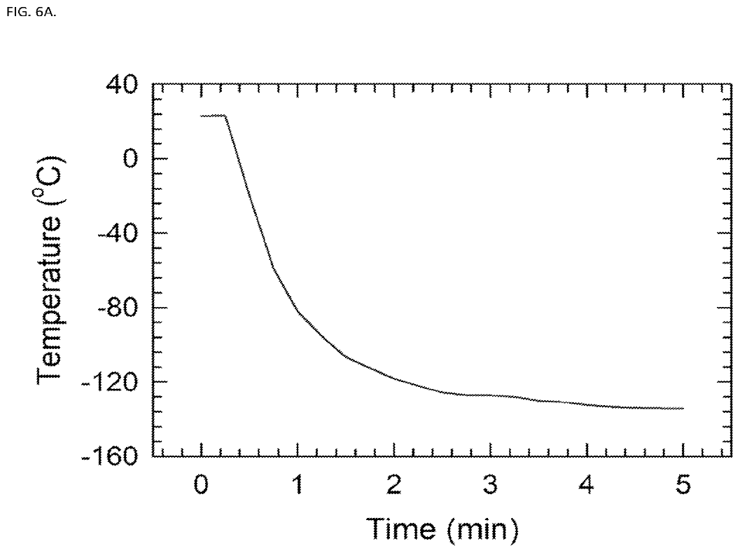

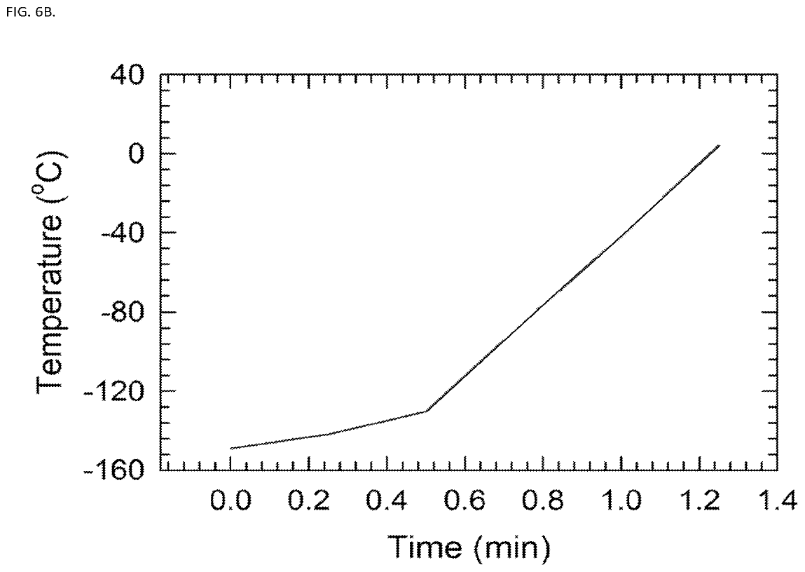

The O-ring was therefore modified to the rounded (torus shaped) ring A of FIG. 1. The preferred inner diameter of the O-ring is 12 mm, but this may vary from 11-13 mm, and the preferred thickness of the O-ring is 1 mm, but may vary from 0.5-4 mm. The O-ring was also attached to the bottom of vertical member (wand) B of FIG. 1 to allow easy transfers from solution to solution, from VS to liquid nitrogen vapor, and from liquid nitrogen vapor to VS for rapid warming. This enabled short term experiments but did not include the ability to protect the cornea from potential damage from mechanical contact with the storage container during long term storage or transport. This latter problem was solved by incorporating the cornea loop and wand into the lid C of the long-term storage container F of FIG. 1. This system enables a) transfer of the cornea from container to container without the need to manually hold or otherwise secure the wand, b) the ability to protect each solution from contamination by using the cornea transfer device A+B+C as a lid for each container during addition and removal of cryoprotectant, c) the ability to prevent contact between the cornea and the floor of each cryoprotectant container and to allow free diffusion around the epithelial side of the cornea during contact with the cryoprotectant, d) the ability to vitrify the cornea by placing the cornea handling device onto and then securing it onto the pre-cooled cornea storage container F and allowing the cornea to vitrify passively within the atmosphere of container F while being protected from contact with condensed water vapor surrounding F or, e) the ability to transfer the cornea to a different cold environment (liquid nitrogen vapor, cold air, or a combination of liquid nitrogen vapor and cold air) for vitrification and then to transfer the vitrified cornea to its storage container F by screwing or snapping the cornea handling device A+B+C onto said storage container, and finally f) the ability to prewarm or fully rewarm the cornea by prewarming or rewarming its storage container as per FIG. 6B (slow warming phase: pre-warming; rapid warming phase: rewarming) and/or to rewarm the cornea by transferring it on its handling device A+B+C to a container of VS at a suitable temperature. Optionally, for easier handling, an extension D of wand B can penetrate through lid C and, if desired, can be embellished with additional member E for easier gripping by hand or by an appropriate gripping device.

Other optional variations of this device and the use of continuous means of adding and removing cryoprotective agents are described above. Gradient-forming means are well known in the art, and may be greatly simplified versions of art developed for cryoprotective perfusion of organs (Fahy 1994).

### EXAMPLE 2: HUMAN CORNEAS SURVIVE EXTREME DEHYDRATION FOLLOWED BY VITRIFICATION: IN VITRO RESULTS (LOADING/UNLOADING METHOD ONE)

Corneas. For the experiments of Example 2, a total of 75 human corneas were obtained from the Lone Star Lions Eye Bank in Manor, Texas, or the Doheny Eye & Tissue Transplant Bank in Los Angeles, California after storage in Optisol-GS for 2-9 days at 4°C. These corneas were deemed unsuitable for clinical transplantation because of arcus or donor systemic disease but retained an intact endothelium and were therefore suitable for our purposes.

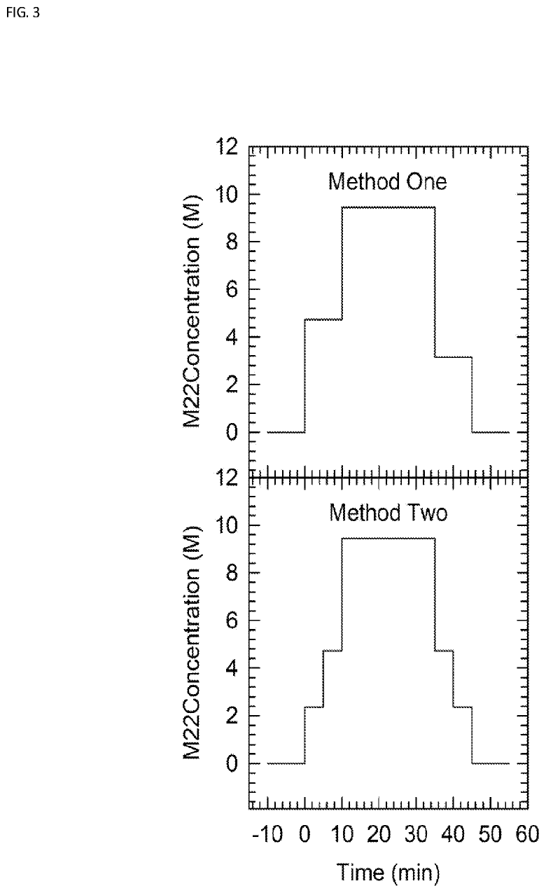

Protocol. The steps of cryoprotectant addition and removal were as described in FIG. 3, Method One. In all experiments involving cryoprotection, M22 was used as the vitrification solution, with LM5 as the carrier solution used for M22 loading, and CPTES plus 2.5% chondroitin sulfate was used as the carrier solution for the M22 washout steps.

For reference, M22 has a total effective molarity, based on equating the osmotic contributions of its polymeric components to molarities (milliosmole for millimole) in the absence of other cryoprotectants (Fahy, Wowk et al. 2004), of 9.45M. The melting point of M22 is about −54.9 °C (Fahy, Wowk et al. 2004). Given the standard dilute solution approximation that freezing point is depressed by 1.86 degrees Celsius for every 1 Osmolal increase in solute concentration, the osmolality of M22 can be crudely estimated to be 54.9°/(1.86°/Osmolal)=29.5 Osmolal (Osm). Given that blood plasma has a freezing point of about −0.55 °C, the normal osmolality of most human cells is about 0.55/1.86=0.296 Osm or 296 milliosmolal (mOsm). Therefore, M22 may be said to be about 100 times as concentrated as plasma on an osmotic basis.

For context, studies on many cells have shown that most cells can tolerate exposure to no more than a four-fold (4×) increase in extracellular osmolality (or a solution that 4 times the isotonic osmolality) in one step (Meryman, Williams et al. 1977). However, we surprisingly found that human corneas can tolerate being immersed directly in half-strength M22 (about 4.73M M22), whose osmolality is at least (4.73+0.296)/0.296=17 times isotonic, for 10 min, transferred into full-concentration M22 for 25 min, vitrified and rewarmed as described below, immersed in 30% of full M22 for another 10 min, and finally transferred into M22-free medium without any osmotic buffer (Method One of FIG. 3) based on multiple in vitro endpoints. All M22 loading and unloading steps were done at 4 °C (isothermal process). Control corneas were held at 4 °C in CPTES plus 2.5% CSA during the loading and unloading of the treated corneas.

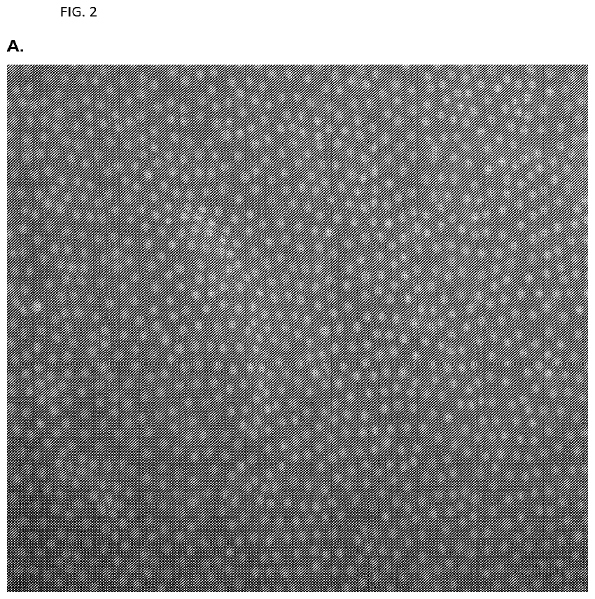

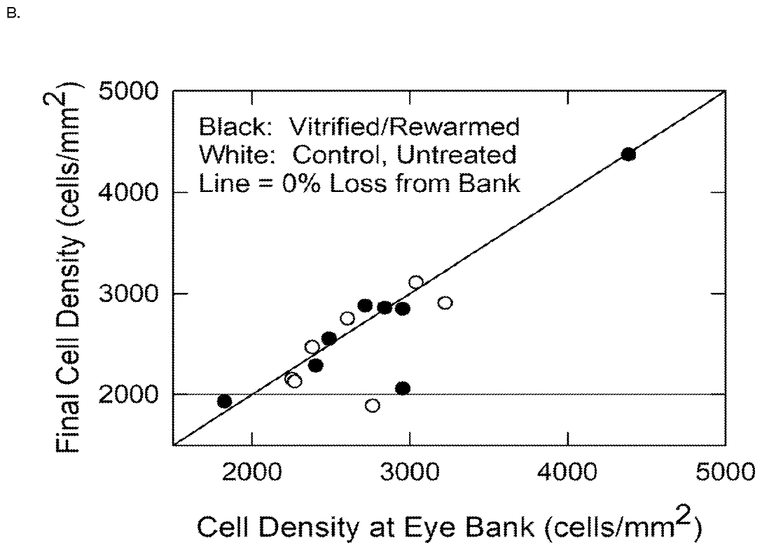

In vitro results and discussion. FIG. 2A and B respectively show the vital staining and ECD results of this protocol. Syto 13 stains the nuclei of viable cells green (Yang, Acker et al. 1998) and ethidium homodimer-1 stains non-viable cell nuclei red. In addition to providing vital staining scores, selective Syto-13 binding to the nucleus provides a convenient way of identifying and therefore of counting individual corneal endothelial cells for calculation of the ECD. Corneas were stained with Syto 13 and ethidium homodimer-1 in D-PBS for 40 minutes at room temperature, and a 7.5 mm button was then trephined from the central region of the cornea for observation and ECD determination. The endothelium was viewed under a fluorescence microscope (Olympus, IMT-2 Inverted research microscope). As shown in FIG. 2A, virtually all corneal endothelial cells (CECs, corresponding to the pale spots in the figure) stained green, with very few red cells apparent after vitrification and M22 washout.

In addition, very few cells were lost from the corneal endothelial monolayer (FIG. 2B). We tested the accuracy of our own ability to determine the ECD [using the Karnama et al. method (Karnama and Khodadoust 1986)] by comparing our ECD counts in control (white points) and vitrified (black points) corneas to the ECD counts reported to us by the originating eye bank for the same corneas before we received the corneas. As can be seen, the data cluster near the line for the equation ECD_{21CM}=ECD_{EB} (0% cell loss at our institution), where ECD_{21CM} is the corneal endothelial cell density as measured at our institution and ECD_{EB} is the corneal endothelial cell density as measured at the eye bank. This was true regardless of whether we counted endothelial cells in vitrified corneas (n=8) or in control (non-vitrified) corneas (n=7), strongly indicating that departures from the line represent measurement error rather than negligible changes induced by vitrification, osmotic stress, corneal “aging” or transportation, or any mishandling in our lab. There are two exceptions, but in one case (black point), a vitrified cornea showed an ECD of just over 2000 vs an expected ECD of around 2900, whereas in another (white point), a control cornea showed an ECD of about 1900 whereas the same cornea at the eye bank had an ECD of about 2750cells/mm², indicating that a loss of ECD is at least as likely in untouched control corneas as in vitrified corneas, again demonstrating no difference in ECD between vitrified and control corneas overall. Statistically, the p values for differences between the means of eye bank counts and our counts were p=0.49 for control corneas and p=0.62 for vitrified corneas. Further, notably, even the ECD of just over 2000 in the vitrified outlier cornea lies above the cutoff line (horizontal line at 2000) for suitability for transplantation.

Massive osmotic corneal dehydration is expected following immersion in a solution that is at least 17 times more concentrated than the LM5 carrier solution the corneas were initially placed in. Further, the corneas were only immersed in this solution for 10 min, whereas Bourne reported that human corneas require more than 20 min at each of 4 loading steps to take up sufficient cryoprotectant to vitrify (Bourne and Nelson 1994). Therefore, after exposure to 50% of full concentration M22, the corneas were still very dehydrated when they were then subjected to another two-fold increase in concentration by being transferred into M22, and the prior art expectation would be that this procedure would be lethal to the cornea. For example, Taylor found that corneas immersed in 3M dimethyl sulfoxide (Me2SO; about 15.8× isotonic) were severely damaged, whereas corneas exposed to the same concentration by transfer first into 1M and then into 2M Me2SO before exposure to 3M recovered (Taylor and Hunt 1989), presumably largely due to the avoidance of osmotic (shrinkage) stress. Nevertheless, in our experiments, surprisingly, the corneas recovered not only after direct exposure to 4.73M M22 but also after another 25 min of exposure to 9.45M M22 at 4 °C.

While not wanting to be bound by any theory, and while we can only speculate as to why this unpredictable survival was observed, we suspect that the first step of this two-step procedure produced so much water loss that corneal cryoprotectant permeability was thereafter essentially abolished, preventing substantial update of M22 cryoprotectants into the cornea once a certain minimum amount of permeation had taken place. Alternatively, and even more probably, following the first massive dehydration step with another large dehydration step to peak concentration (which has never been contemplated in the prior art due to the expectation that this would be fatal) may have completed the curtailment of CPA uptake. Maximally shrunken cells containing relatively little intracellular water may have cell interiors too dense and viscous (intracellular protein concentrations too high) for additional cryoprotectant to enter, or there may be modification of cell membrane permeability, or both. This would also explain the extraordinary tolerance of these corneas to dilution. Substantial equilibration of M22 into the corneas during M22 loading would result in massive osmotic swelling of the cornea in general and of its cells in particular upon rapid dilution without an osmotic buffer (Taylor and Hunt 1989, Meryman 2007), but this was not observed. However, critically, the inventors found that corneas held in M22 for only 20 min before cooling formed ice on cooing, whereas holding in M22 for 25 min precluded ice formation, implying that water efflux from the corneas continues between 20 and 25 min of M22 contact for the described protocol. Thus, the most preferred holding time in M22 is 21-25 min, and especially 23-25 min, for this protocol.

However, in another protocol involving a 3-5 min exposure to 50% M22, 9-10 min exposure to M22, and 5 min exposure to 30% of full M22 before dilution to 0% M22, no ice was formed, and good recovery was obtained (data not shown). Therefore, overall, the minimum holding time at the peak concentration of the protocol is at most 9-10 min.

Another factor that may have facilitated survival is the short total CPA exposure time enabled by the very short loading and the very short unloading process. However, normally CPA toxicity proceeds most rapidly at the highest concentration used, and in this case, exposure to full M22 lasted 2.5 times longer than exposure to either the loading solution or the unloading solution, which is another unique feature of the present method. Prolonged exposure to M22, or to the highest concentration used in the process if this is not M22, is believed to be beneficial to ensure extraction of sufficient water from the cornea by osmosis to preclude ice formation during cooling and warming, the dilution tolerance evidence above and the DSC evidence described below indicating that it is this dehydration rather than M22 uptake into the cornea that is primarily responsible for stabilization of the cornea against ice formation.

But it is surprising that the corneal endothelium was able to tolerate such massive shrinkage and such massive dilution without osmotic buffering during the latter. This tolerance is not predictable from studies on isolated corneal endothelial cells, which predict cell death after exposure to a step change to 4.4 times isotonic media (<<17X isotonic) or after dilution of cells equilibrated with 0.25M Me2SO (equivalent to only 2.6% of the concentration of M22 or 8.8% of the concentration of 30% of full-strength M22) to 0M Me2SO in one step (Taylor and Hunt 1989). Aside from cellular survival, it is also a wonder that the endothelium was able to remain attached to the cornea. We note that M22 is so named because it is intended to be brought into contact with living cells only at temperatures close to −22 °C to preclude toxicity at higher temperatures, but our corneas tolerated prolonged exposure to it at 4 °C when treated with M22 as described.

The theory of cryoprotectant uptake inhibition is independent of the nature of the cryoprotectant provided a sufficiently high concentration is introduced sufficiently rapidly. However, prevention of cellular CPA uptake will also be facilitated by the presence of npCPAs sufficient to elevate the tonicity of the CPA carrier solution appreciably. CPTES, which is a carrier used in past corneal studies, contains 2.5% chondroitin sulfate (CS), a negatively charged glycosaminoglycan, which may be regarded as a non-penetrating CPA. However, given the molecular weight of this molecule (mean, ~40,000 daltons, range ~25,000-80,000 daltons), the osmotic contribution of 2.5% CS is predicted to be about 25/40,000~0.6 mOsm, which is not enough to measurably change the tonicity of CPTES. The exemplary M22 solution, on the other hand, contains an npCPA polymer mixture that raises the tonicity of its carrier solution to about 1.5 times isotonic, and the present invention can be usefully practiced with the optional but beneficial inclusion of VS npCPAs that raise the tonicity of the carrier solution to 1.2-1.7 times isotonic [as calculated in the absence of cryoprotectants (Fahy, Wowk et al. 2004)] or above for inhibition of CPA uptake.

The cooling and warming methods used in these studies are described in Example 3.

### EXAMPLE 3: HUMAN CORNEAS SURVIVE EXTREME DEHYDRATION FOLLOWED BY VITRIFICATION: IN VIVO RESULTS WITH HUMAN-TO-RABIIT XENOGRAFTS (LOADING/UNLOADING METHOD TWO)

To further define the metes and bounds of the invention and to rigorously verify the survival and functional recovery of vitrified corneas, a second extreme dehydration protocol was investigated and evaluated by transplanting 15 vitrified corneas into rabbits and comparing their performance to the performance of four control human corneas. For these experiments, the M22 loading and unloading process was modified to the following steps: 25% M22, 5 min; 50% M22, 5 min; 100% M22, 25 min; 50% M22, 5 min; 25% M22, 5 min; 0% M22, 10 min (Method Two of FIG. 3). Again, the carrier of M22 addition was LM5 (as always, minus calcium and magnesium) and the carrier for M22 subtraction was CPTES plus 2.5% chondroitin sulfate, and all steps were once again carried out at 4 °C. The two protocols shown in FIG. 3 have in common the fact that the time spent going from no CPA to 100% of full VS concentration is 10 minutes in each case, which is unheard of in the art. Similarly, with both methods, the time taken to proceed from 100% VS to 0% VS is 10 minutes, which is also unheard of in the art, especially without the use of osmotic buffers, which neither method employed. Vitrified corneas that were transplanted were stored at −145 °C for 2-174 days (mean and standard deviation: 35±47 days) before rewarming and transplantation. No effect of storage time was apparent.

All animal use was conducted with the approval of the institutional animal care and use committee of 21st Century Medicine, Inc., and were in compliance with current USDA and the NIH guidelines. Male New Zealand white rabbits (Harlan Sprague Dawley, Indianapolis, IN) weighing 2.8-3.5 kg were premedicated and anesthetized according to standard approved procedures and received human xenografts to the right eye only, leaving the left eye available for normal vision. The surgical method was similar to that of Beyer et al. (Beyer, Lin et al. 1990) and Khodadoust et al. (Khodadoust 1968). The globe was exposed and immobilized, and a 7.5 mm diameter central corneal disk was removed from the recipient cornea and replaced with a 7.5 mm diameter corneal button from the vitrified/rewarmed human cornea. The anterior chamber was allowed to reform spontaneously, and atropine eye drops were applied at the end of the procedure. The postoperative care required was occasional atropine drops when the pupil was miotic. Antibiotics, such as gentamicin, neomycin/polymixin B/Dexamethasone ointment, and steroids such as prednisone acetate eye drops were used when needed. All grafts were observed and photographed daily for graft clarity, wound dehiscence, infection, etc. To avoid rejection, grafted corneas were removed at 10±3 days (mean±standard deviation) postoperatively. Corneas were fixed in 2.5% glutaraldehyde and divided for examination by light microscopy (histopathology), scanning electron microscopy (SEM), and transmission electron microscopy (TEM), and all cornea evaluations were performed by a consulting ocular pathologist located at a different institution in blind fashion.

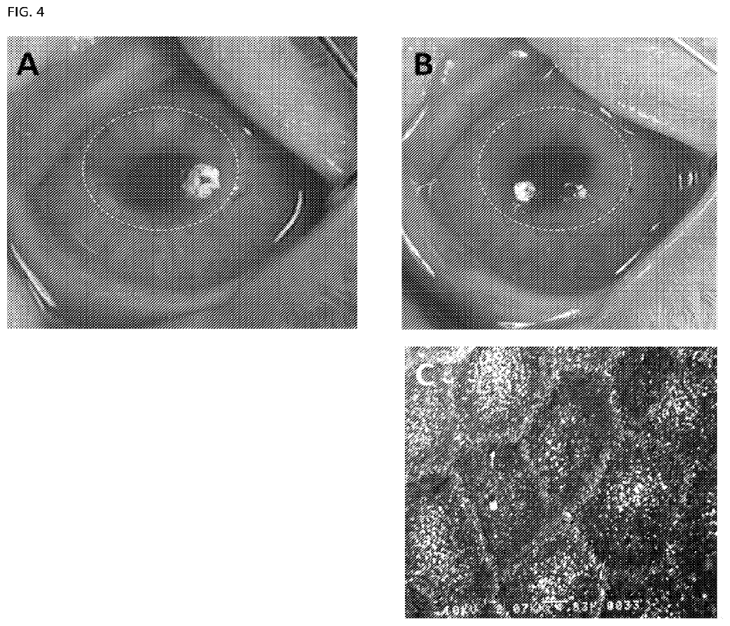

Visually, ten of 19 grafts remained clear from the first postoperative day, while 5 showed a slight haziness for the first two days that cleared on day 4-7 and affected the epithelium more than the endothelium. Overall, we did not see any difference between control and vitrified corneas. One clear control and one clear vitrified graft are shown in FIG. 4A and in FIG. 4B, respectively. The circular dotted lines show the junctions between the grafts and the recipient corneas. Histologically, vitrified corneas showed apparently intact layers after vitrification although there was some loss of epitheliumFIG. By SEM, the endothelial layers of vitrified/rewarmed grafts (FIG. 4C) were seen to be preserved similarly to those of control FIG.grafts (not shown). FIG. Endothelial cells were flat and appeared to be intact, with easily identified borders. Transmission electron microcopy of vitrified and xenografted human corneas showed a relatively normal endothelium with some alterations consistent with a continuation of good function in the absence of a xenograft reaction and with appropriate attachment of the endothelium to Descemet's membrane (results not shown).

Graft clarity after transplantation demonstrates the survival of donor endothelium. Donor graft endothelium replacement by proliferating host endothelium in the rabbit does not begin until after the 4th postoperative day (Nakahori, Katakami et al. 1996), so endothelial failure prior to 4 days would necessarily result in graft cloudiness, which was not observed. In fact, the functional performance of these vitrified human transplants exceeded that of human corneas transplanted after organ culture, which remain opalescent for up to 4 weeks postoperatively (Redmond, Armitage et al. 1992). Second, evaluation by our consulting pathologist indicated that peripheral clouding noted on day 15 postoperatively represented invasion by host immune cells. But this also implies survival of donor endothelium sufficient to engender an immune response on day 15. Remarkably, there was dramatically less inflammatory infiltration in the vitrified-rewarmed graft but no evident reduction in ECD compared to the control. Moreover, it has been observed in rabbit-to-rabbit corneal transplants that donor endothelial replacement by host endothelium is associated with 10-14 days of corneal cloudiness (Chi, Teng et al. 1965), and this was not observed. Therefore, it is likely that human endothelial cells on a vitrified-rewarmed cornea are able to maintain stromal hydration within limits compatible with normal corneal clarity for many days after transplantation but appear to be less immunogenic than control corneal endothelial cells.

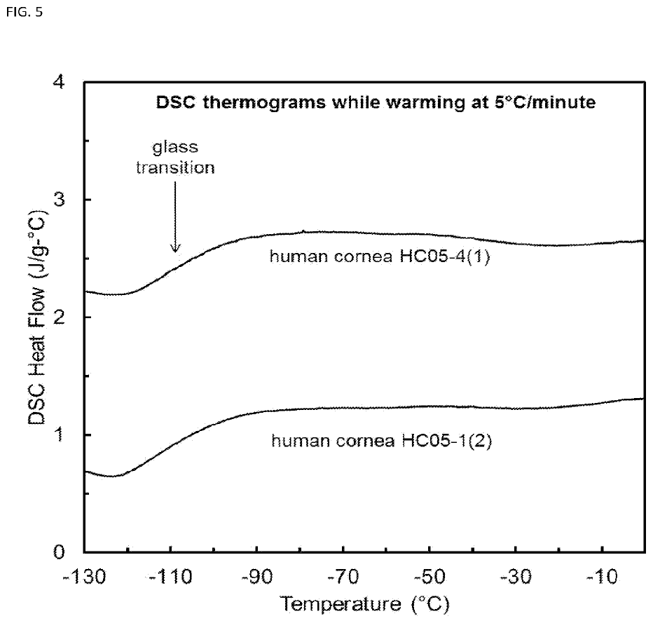

Differential Scanning Calorimetric Studies of Corneas Vitrified by Method Two. To verify the ability of corneas treated as described to escape from ice formation during both cooling and warming, differential scanning calorimetry (DSC) studies were undertaken on 3 usable corneal samples treated by the second M22 loading and unloading protocol. Two corneal samples [one of 4.8 mg, for cornea HC05-17(2) and one of 12.7 mg, for cornea HC05-4(1)] were cooled from +10 °C to −150 °C at 5, 10, 20, 40, and 80 °C/min and then rewarmed to the starting temperature at the same rate. The thermograms showed no evidence of freezing or melting, indicating that the cornea tissue remained perfectly ice free during cooling and rewarming at all examined rates, and that the corneas were undoubtedly also stable against ice formation even at cooling and warming rates of less than 5 °C/min. The only observable event was a glass transition at a temperature of −110°C in one cornea and −97°C in a second cornea. A third cornea (16.2 mg) was cooled at 100 °C/min to −150 °C and then rewarmed at 5, 10, 20, 40, or 80 °C/min. No ice melting peak was seen at any warming rate in this cornea as well, signifying that this cornea, like the others, was undoubtedly stable against ice formation even at warming rates of less than 5 °C/min. A glass transition was seen in this cornea at −110 °C. Representative thermograms for the first and third corneal samples are presented in FIG. 5. These results were consistent also with macroscopic observations. There was no visible ice formation or cracking on cooling in either the cornea or the M22 contained in the “bowl” of the cornea after cooling to −134 °C. Further, no cracking and no obvious devitrification was observed by eye on warming.

Crucially, the glass transition temperatures observed in the three samples (−110 °C, −110 °C, and −97 °C) are all dramatically higher than the glass transition temperature of the pure M22 cryoprotectant solution that was used to prevent the corneas from freezing, which is 124 °C. It is extraordinary for the glass transition temperature of tissue to differ substantially from the cryoprotectant solution it is permeated with, and the difference can only be explained by water extraction from the cornea out of proportion to the water content of M22, which will have the effect of increasing corneal protein concentration and thereby raising TG (Rasmussen 1969). This osmotic and chemical disequilibrium between the cornea and its M22 environment (osmotic water extraction) creates a greater fluid viscosity in the cornea than in other tissues prepared for vitrification, causing corneas to solidify at much higher temperatures than other tissues would and to achieve extraordinarily strong resistance to ice formation on either cooling or warming.

Additional evidence for this conclusion comes from the fact that the magnitude of the glass transition, which reflects the water content of the tissue, was also dramatically smaller than is seen for other tissues and CPA solutions. The change in heat capacity in the corneas was approximately 0.6 J/(g °C), whereas the change in heat capacity of CPA solutions is typically closer to 2 J/(g °C) through the glass transition, suggesting a reduction in water content by about three-fold in comparison to what is typical for ordinary systems, which is extraordinary given that the water content of M22 is already only about 41% of the solution's volume. Additional evidence of dehydration was a perceived stiffening of the cornea after M22 loading.

Cooling and Warming Methods Used. Cooling and warming were done in the same way for both Method One and Method Two corneas. Vitrification was done on or near a 14.6 cm tall platform placed in an MVE E-1 cylindrical dewar containing liquid nitrogen to a depth of 13-14 cm (nominal 1.6-0.6 cm separation between the liquid nitrogen surface and the platform). A thin-walled small plastic screw-cap container (capacity, 20 ml) was positioned on the platform for pre-cooling to −170 to −190 °C. The cornea, positioned endothelium side up on its O-ring, was placed into the atmosphere in the dewar adjacent to the container and over a pre-cooled solid surface that accelerated cooling (later found to be unnecessary) and reduced frost contact with the cornea, but the cornea could also be placed directly into the container as described above, without allowing contact between the cornea and the container floor. The “bowl” of the cornea was deliberately not emptied of VS, and contained ~0.5-1 ml M22, which was sufficient to shield the endothelium from atmospheric ice and enable an appropriate cooling rate but insufficient to support potentially damaging fracturing of the M22.

The cornea was allowed to cool passively to −134 °C (a typical cooling profile is shown in FIG. 6A) and then transferred in its sealed container to a constant-temperature storage system for storage at −145 °C. Vitrification in a container is preferred for reducing or preventing contamination of the cornea and avoiding direct contact between the cornea and droplets of liquid nitrogen but may result in a slower cooling rate than exposure of the cornea to the dewar atmosphere outside of a container, which could in theory be important for difficult-to-vitrify corneas.

For warming, the cornea was pre-warmed to −135 °C to relieve accumulated stresses and prevent cracking upon fast warming and then transferred on its ring into 100-250 ml of 4 °C M22 and gently agitated until the solid M22 solution within the cornea liquified. The average warming rates (see FIG. 6B) were far higher than the rates required to avoid devitrification according to DSC measurements (see below). Corneas rewarmed in this way avoided most visible devitrification and did not crack.

### EXAMPLE 4: HUMAN CORNEAS SURVIVE EXTREME DEHYDRATION FOLLOWED BY VITRIFICATION: IN VIVO RESULTS WITH LONG-TERM (4-MONTH) HMAN-TO-MONKEY XENOGRAFTS (LOADING/UNLOADING METHOD TWO)

Human corneas stored in Optisol-GS for 2-10 days at 4 °C were obtained from Lone Star Lions Eye Bank, Manor, or Doheny Eye & Tissue Transplant Bank, Los Angeles. We vitrified and stockpiled corneas at −145 °C for up to 161 days as per the methods described above. As before, there was no visible ice formation or cracking during vitrification.

The inventors took stockpiled corneas to St. Kitts (in a shipper specifically designed to maintain corneas below TG and above the temperature of liquid nitrogen during transport) whenever we were able to arrange for transplants of fresh, non-vitrified corneas. Control human corneas were directly shipped from the eye bank to the Behavior Science Foundation of St. Kitts since these corneas deteriorate with time. There were no statistically significant differences between vitrified and control donor sex, postmortem time, cold storage time, or age, although most control corneas were affected by arcus, whereas vitrified corneas were not.

In total, 8 vitrified and 8 control corneas were transplanted under good conditions into vervets at the Behavioral Science Foundation on St. Kitts where an approved facility for primate surgical studies is located. Anesthesia was as per the Behavioral Science Foundation's standard protocols, and our surgical methods were as per our xenografting experiments with rabbits except that we transplanted 6.5 mm cornea punches to 6 mm recipient corneal gaps. There was no cracking or devitrification during warming on St. Kitts except in the case of cornea 9, which displayed some ice formation on warming and happened to have been stored for the longest time. The mean storage time at −145 °C was 70.6±54.23 days

All grafts were observed daily postoperatively for graft clarity, epithelial healing, wound dehiscence, infection, and inflammation by BSF staff. Grafts were photographed daily for the first week, thereafter at 2 weeks and at 1, 2, 3, and 4 months after transplantation. The monkeys were anesthetized, and eyes were examined using a Nidek ConfoScan 3 human clinical specular microscope by BSF staff at 2 weeks, 1, 2, 2.5, 3 and 4 months after xenografting and the images were recorded and transmitted to us by BSF staff. The ConfoScan 3 provides analyses of corneal endothelial cell characteristics and density as well as corneal thickness. Each ECD result was the mean of measurements made by counting endothelial cells in different photographic fields of known area from each cornea. ECDs and corneal thicknesses were measured in blind fashion. At the end of the follow-up period for each monkey, BSF personnel euthanized the monkeys, removed and fixed the corneas, and sent them to our consulting ocular pathologist, who evaluated them in blind fashion for general condition and standardized corneal grading using a semi-quantitative 5-point system in which 5 is a perfect score and 1 represents widespread destruction.

Of the 8 control corneas, only three corneas became at least partially clear, the rest becoming permanently cloudy. Of the 8 vitrified corneas, six became clear and remained clear until follow-up at 169 days after having been somewhat hazy for the first several postoperative days. One of the two cloudy corneas was cornea 9, which experienced devitrification upon rewarming (breach of temperature maintenance during storage?). On average, 5 of 8 control corneas could be at least partially evaluated by specular microscopy despite cloudiness, the onset time for endothelial visibility averaging 64.6 days after transplantation (range, 18-119 days). Of the 8 vitrified corneas, all but cornea 9 could be visualized well enough by the Confocan 3 to be evaluated, after a visibility onset time averaging 20.9 days (range, 14-26 days). The difference between the two groups may arise in part from deterioration of the control corneas during shipment, which is the problem vitrification is intended to solve. There was no influence of transportation temperature on the vitrified corneas, comparing corneas shipped at −145 °C (n=3) to those shipped at −180 °C (n=5).

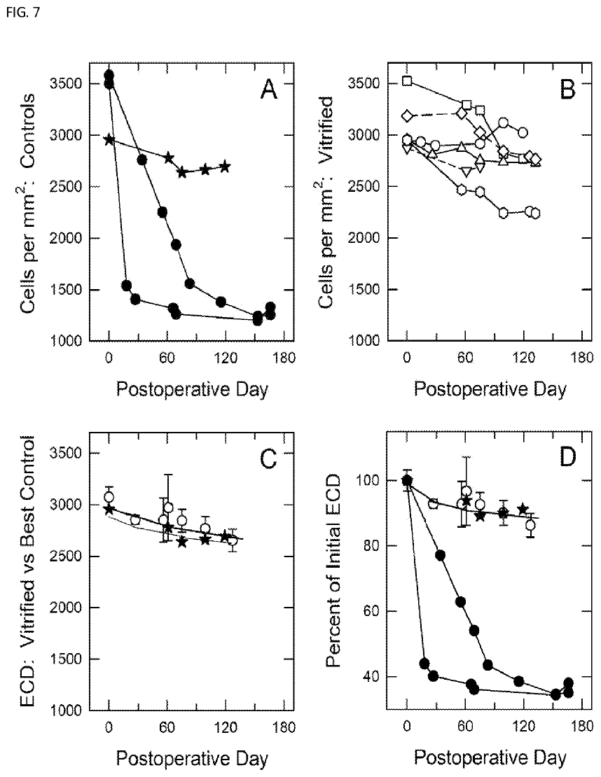

One of the most important factors for the long-term success of cornea transplantation is the rate of decline of ECD over time after transplantation. A comparison of changes in ECD between control and vitrified corneas is displayed in FIG. 7. Panel A of FIG. FIG. 7 records ECD decline in the three evaluable control corneas, and panel B records ECD changes in the six evaluable vitrified corneas. Of the control corneas, only one maintained ECD well after transplantation (stars), whereas 6 of 6 evaluable vitrified corneas did so. Panel C shows the mean results (±1 SEM) for the vitrified corneas (white points) and compares them to the one good quality control cornea result (stars), showing that the average quality vitrified cornea is just as good as the best possible control, implying that vitrification has caused no change in the ECD decline expected for pristine controls. The regression line for the vitrified corneas was ECD=2700+330*exp[−0.0117 t] where t is given in days and predicts a plateau of ECD at 2700 cells/mm2 in about 1 year. Panel D presents the same data normalized to the ECD before transplantation (±1 SE). Vitrified corneas (white points) retain on average over 90% of the ECD over 4 months in a non-human host, as does the one good control cornea (stars), whereas the other two controls show ECD declines of more than 60%.

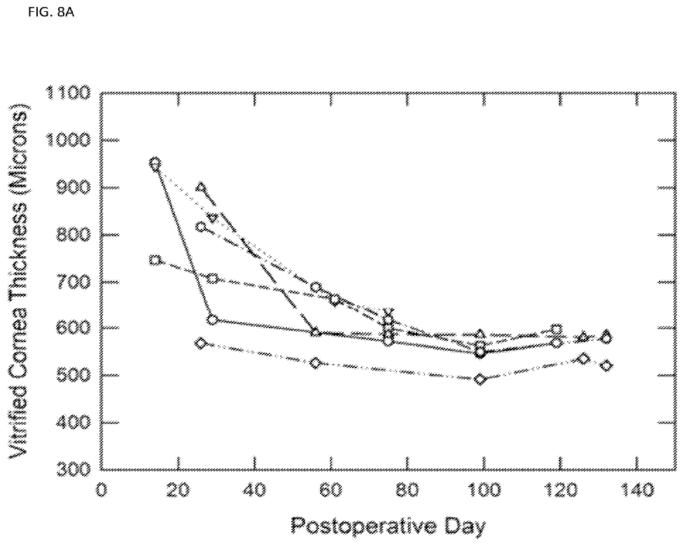

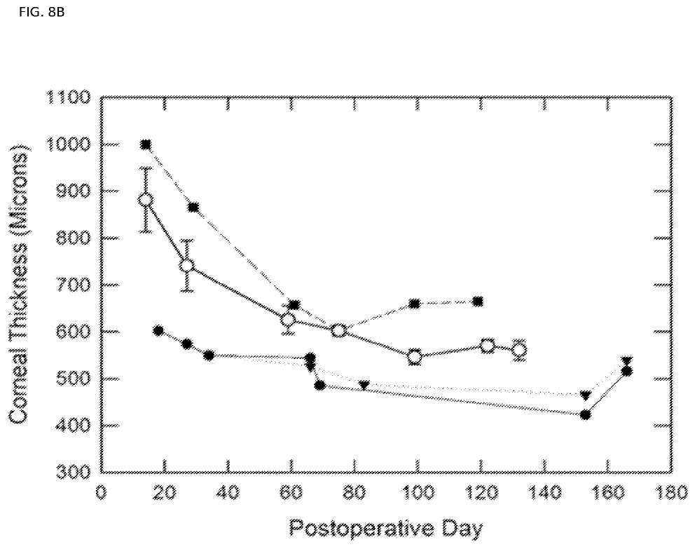

Corneal thickness is a fundamental measure of corneal health, and corneal thickness measurements are presented in FIG. 8. Both vitrified corneas (upper graph) and control corneas (lower graph, black points) tended to be thicker than normal for the first 1-2 months after transplantation, but ultimately recovered, with the average vitrified cornea (white points in the lower graph) behaving very much like the high-ECD control cornea (designated by boxes in the lower graph) and like control corneas in general, again suggesting the normalcy of the vitrified corneas after transplantation.

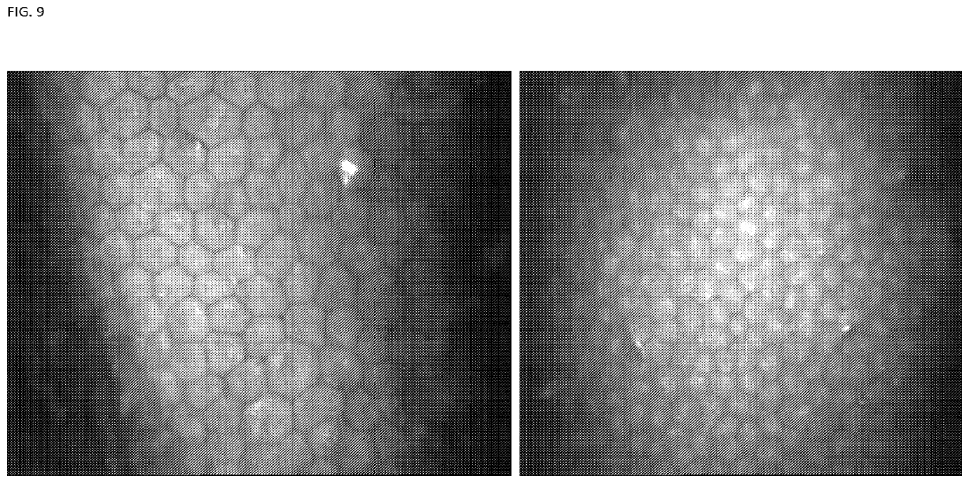

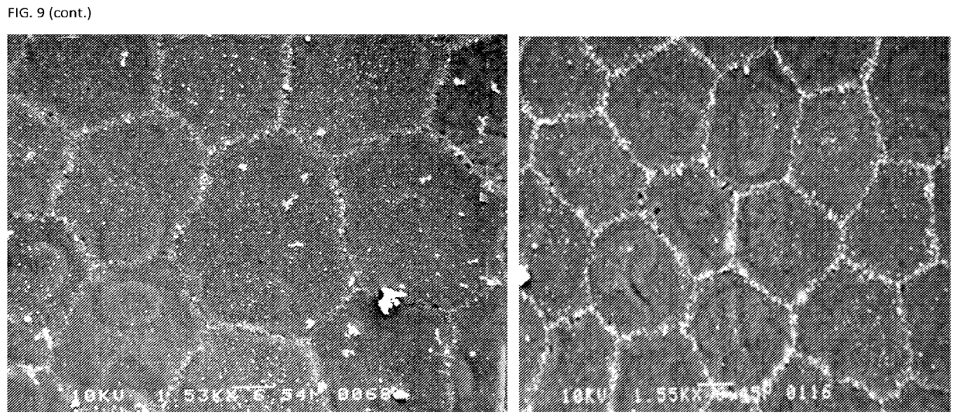

FIG. 9 displays the structural findings for endothelial cell morphology in representative control (upper left) and vitrified (upper right) human-to-monkey transplanted corneas as imaged by the ConfoScan 3 after 153 and 126 days in vivo, respectively. Morphology appeared normal in both, but as can be seen by these equal magnification images, control corneas tended to have larger cells in keeping with their lower ECDs. FIG. 9 also shows control (bottom left image) and vitrified (bottom right image) central SEM findings, which do not indicate any defects in endothelial layer structure in the vitrified and transplanted corneas.

The blinded pathological scoring results for these corneas showed that three of eight control corneas and six out of 8 vitrified corneas got better scores, which independently confirms our in vivo results.

### EXAMPLE 5: SURVIVAL OF RABBIT CORNEAS VITRIFIED AFTER ONE-STEP INTRODUCTION AND WASHOUT OF M22

The inventors have also demonstrated that rabbit corneas survive direct transfer from cryoprotectant-free media into M22 and direct transfer from M22 to cryoprotectant free media based on vital staining results and maintenance of excellent ECD (data not shown).

All publications, patents, patent applications and other documents cited in this application are hereby incorporated by reference in their entireties for all purposes to the same extent as if each individual publication, patent, patent application or other document were individually indicated to be incorporated by reference for all purposes.

While various specific embodiments/aspects have been illustrated and described, it will be appreciated that various changes may be made without departing from the spirit and scope of the disclosure.

### REFERENCES CITED IN THE APPLICATION

Abazari, A., L. G. Meimetis, G. Budin, S. S. Bale, R. Weissleder and M. Toner (2015). “Engineered trehalose permeable to mammalian cells.” PLOS One 10(6): e0130323.

Anonymous. (2003). “40,000 lose eyesight every year.” from www.healthlibrary.com/news/Sep03/8_13sep/news9.htm.

Anonymous (2003). “Table 3. Number of deaths and death rates, by age, race, and sex: United States, 2001.” National vital statistics reports 52: 22.

Anonymous. (2003). “World wide demand for corneal transplantation far outstrips donor tissue availability international agencies find.” from www.escrs.com/eurotimes/july/cornael.asp.

Armitage, W. J. (1989). “Survival of corneal endothelium following exposure to a vitrification solution.” Cryobiology 26: 318-327.

Armitage, W. J., A. D. Dick and W. M. Bourne (2003). “Predicting endothelial cell loss and long-term corneal graft survival.” Investigative ophthalmology & visual science 44: 3326-3331.

Armitage, W. J. and D. L. Easty (1997). “Factors influencing the suitability of organ-cultured corneas for transplantation.” Investigative ophthalmology & visual science 38: 16-24.

Armitage, W. J., S. C. Hall and C. Routledge (2002). “Recovery of endothelial function after vitrification of cornea at −110 °C.” Investigative ophthalmology & visual science 43: 2160-2164.

Beyer, C. F., D. T. C. Lin and M. S. Insler (1990). “An improved technique for experimental penetrating keratoplaty in rabbits.” Ophthalmic Surg 21: 191-195.

Bourne, W. M. (2001). “Cellular changes in transplanted human corneas.” Cornea 20: 560-569.

Bourne, W. M. and L. R. Nelson (1994). “Human corneal studies with a vitrification solution containing dimethyl sulfoxide, formamide, and 1,2-propanediol.” Cryobiology 31: 522-530.

Bourne, W. M., D. R. Shearer and L. R. Nelson (1994). “Human corneal endothelium tolerance to glycerol, dimethylsulfoxide, 1,2-propanediol, and 2,3-butanediol.” Cryobiology 31: 1-9.

Brunette, I., M. Le Francois, M. C. Tremblay and M. C. Guertin (2001). “Corneal transplant tolerance of cryopreservation.” Cornea 20: 590-596.

Brunette, I., L. R. Nelson and W. M. Bourne (1989). “A system for long-term corneal perfusion.” Investigative Ophthalmol Visual Sci 30(8): 1813-1822.

Brunette, L., L. R. Nelson and W. M. Bourne (1989). “Tolerance of human corneal endothelium to glycerol.” Cryobiology 26: 513-523.

Campbell, R. (2000). Body parts end up abroad. The Orange County Register.

Canals, M., J. Costa, J. M. Potau, M. D. Merindano, D. Pita and D. Ruano (1996). “Long-term cryopreservation of human donor corneas.” European Journal of Ophthalmology 6: 234-241.

Capella, J. A., H. E. Kaufman and J. E. Robbins (1965). “Preservation of viable corneal tissue.” Cryobiology 2: 116-121.

Chi, H. H., C. C. Teng and H. M. Katzin (1965). “The fate of endothelial cells in corneal homografts.” American Journal of Ophthalmology 59: 186-191.

Ehlers, N. and S. Sperling (1983). “Ultrastructure of cryopreserved, functioning human corneal endothelium.” Acta ophthalmologica 61: 245-253.

Ehlers, N., S. Sperling and T. Olsen (1982). “Post-operative thickness and endothelial cell density in cultivated, cryopreserved human corneal grafts.” Acta ophthalmologica 60: 935-944.

Elliott, G. D., S. Wang and B. J. Fuller (2017). “Cryoprotectants: A review of the actions and applications of cryoprotective solutes that modulate cell recovery from ultra-low temperatures.” Cryobiology 76: 74-91.

Fahy, G. M. (1994). “Organ perfusion equipment for the introduction and removal of cryoprotectants.” Biomedical Instrumentation and Technology 28: 87-100.

Fahy, G. M. (2005). Advantageous carrier solution for vitrifiable concentrations of cryoprotectants, and compatible cryoprotectant mixtures. U.S.

Fahy, G. M., D. R. MacFarlane, C. A. Angell and H. T. Meryman (1984). “Vitrification as an approach to cryopreservation.” Cryobiology 21: 407-426.

Fahy, G. M. and B. Wowk (2021). Principles of ice-free cryopreservation by vitrification. Cryopreservaiton and freeze-drying protocols (Methods Mol Biol 2180). W. F. Wolkers and H. Oldenhof. New York, Humana Press: 27-97.

Fahy, G. M., B. Wowk, J. Wu, J. Phan, C. Rasch, A. Chang and E. Zendejas (2004). “Cryopreservation of organs by vitrification: perspectives and recent advances.” Cryobiology 48: 157-178.

Fuller, B. J. (2004). “Cryoprotectants: the essential antifreezes to protect life in the frozen state.” Cryo-Letters 25: 375-388.

Goto, S., A. Fukuhara and H. Miyasaka (1999). “Therapeutic keratoplasty using preserved corneas from keratoconus eyes.” Japan Journal of Ophthalmology 43: 517-521.

Henaff, F. (1960). Preparation of grafts of freeze-dried cornea. Recent Research in Freezing and Drying. A. S. Parkes and A. U. Smith. Oxford, Blackwell Scientific Publications: 295-302.

Hollins, E. (2000). Personal Communication.

Hu, F.-R., A.-C. Tsai, I.-J. Wang and S.-W. Chang (1999). “Outcomes of penetrating keratoplasty with imported donor corneas.” Cornea 18: 182-187.

Ing, J. J., H. H. Ing, L. R. Nelson, D. O. Hodge and W. M. Bourne (1998). “Ten-year postoperative results of penetrating keratoplasty.” Ophthalmology 105: 1855-1865.

Karnama, Y. and A. A. Khodadoust (1986). “Corneal endothelium in penetrating keratoplasty.” Am J Ophthalmol 102: 66-71.

Khirabadi, B. S. and G. M. Fahy (1994). “Cryopreservation of the mammalian kidney. I. Transplantation of rabbit kidneys perfused with EC and RPS-2 at 2-4 °C.” Cryobiology 31: 10-25.

Khodadoust, A. A. (1968). “Penetrating keratoplasty in the rabbit.” Am J Ophthalmol 66: 899-905.

Kingsley, D. (2002). “Aussie cornea helps fight world blindness.” from www.abc.net.au/science/news/health/HealthRepublish_574406.htm.

Linner, J. G. and J. D. Goosey (1986). Apparatus and method for cryopreparing corneal tissue for surgical procedures. USPTO. USA.

McGinn, P. (2003). “Corneas for the World: EuroTimes visits Tissue Banks International, Baltimore, USA.” from www.escrs.com/eurotimes/july/eyebank.asp.

Meryman, H. T. (1971). “cryoprotective Agents.” Cryobiology 8: 173-183.

Meryman, H. T. (2007). “Cryopreservation of living cells: principles and practice.” Transfusion 47: 935-945.

Meryman, H. T., R. J. Williams and M. S. J. Douglas (1977). “Freezing injury from ”solution effects“ and its prevention by natural or artificial cryoprotection.” Cryobiology 14: 287-302.

Nakahori, Y., C. Katakami and M. Yamamoto (1996). “Corneal endothelial cell proliferation and migration after penetrating keratoplasty in rabbits.” Japan Journal of Ophthalmology 40: 271-278.

Niederkorn, J. Y. (2003). “The immune privilege of corneal grafts.” Journal of leukocyte biology 74: 167-171.

Probst, L. E., B. A. Halfaker and E. J. Holland (1997). “Quality of corneal donor tissue in the greater-than-75 age group.” Cornea 16: 507-511.

Rasmussen, D. (1969). “A note about ”phase diagrams“ of frozen tissues.” Biodynamica 10: 333-339.

Redmond, R. M., W. J. Armitage, J. Whittle, S. J. Moss and D. L. Easty (1992). “Long-term survival of endothelium following transplantation of corneas stored by organ culture.” British journal of ophthalmology 76: 479-481.

Rich, S. J. and W. J. Armitage (1991). “Corneal tolerance of vitrifiable concentrations of propane-1,2-diol.” Cryobiology 28: 159-170.

Rich, S. J. and W. J. Armitage (1991). “The potential of an equimolar combination of propane-1,2-diol and glycerol as a vitrification solution for corneas.” Cryobiology 28: 324-326.

Rob, C. and H. H. G. Eastcott (1954). The preservation of arteries and other tissues for clinical use. Preservation and Transplantation of Normal Tissues. G. E. W. Wolstenholme and M. P. Cameron. London, Churchill: 190-195.

Rodriguez-Fernandez, S., M. Alvarez-Portela, E. Rendal-Vazquez, M. Pineiro-Ramil, C. Sanjurjo-Rodriguez, R. Castro-Vinuelas, J. Sanchez-Ibanez, I. Fuentes-Boquete and S. Diaz-Prado (2021). “Analysis of cryopreservation protocols and their harmful effects on the endothelial integrity of human corneas.” Int J Mol Sci 22(22): 12564.

Routledge, C. and W. J. Armitage (2003). “Cryopreservation of cornea: a low cooling rate improves functional survival of endothelium after freezing and thawing.” Cryobiology 46: 277-283.

Serdarevic, O., M. Berry and D. F. Heller (2015). Corneal vitrification, methods and devices to produce corneal vitrification and methods of use thereof. USPTO. USA.

Taylor, M. J. (1986). “Clinical cryobiology of tissues: preservation of corneas.” Cryobiology 23: 323-353.

Taylor, M. J. and C. J. Hunt (1989). “Hypothermic preservation of corneas i a hyperkalemic solution (CPTES). II. Extended storage in the presence of chondroitin sulphate.” Br J Ophthalmol 73:792-802.

Taylor, M. J. and C. J. Hunt (1989). “Tolerance of corneas to multimolar dimethyl sulfoxide at 0 °C.” Investigative Ophthalmol Visual Sci 30: 400-412.

Thuret, G., C. Chiquet, F. Bernal, S. Acquart, J.-P. Romanet, M. Mouillon, H. Hegelhoffer, C. Burillon, O. Damour, J. Maugery, W. J. Armitage and P. Gain (2003). “Prospective, randomized clinical and endothelial evaluation of 2 storage times for corneal donor tissue in organ culture at 31 °C.” Archives of Ophthalmology 121:442-450.

Van Horn, D. L. and R. O. Schultz (1974). “Endothelial survival in cryopreserved human corneas: a scanning electron microscope study.” Investigative ophthalmology 13: 7-16.

Weiss, P. and A. C. Taylor (1944). “Transplantation of frozen-dried cornea in the rat.” Anatomical Record 88:465.

Wilkins, L. M. and S. R. Watson (1996). Cryopreservation of cultured skin or cornea equivalents with agitation. USPTO. USA.

Yang, H., J. Acker, A. Chen and L. McGann (1998). “In situ assessment of cell viability.” Cell transplantation 7: 443-451.

1. A method for cryopreserving a human, animal, or bioartificial cornea by vitrification, comprising placing the cornea in a cryoprotectant solution and increasing the cryoprotectant concentration in the solution surrounding the cornea from 0% of the target cryoprotectant concentration for vitrification to 100% of the target cryoprotectant concentration for vitrification in 0-25 min, in contact with the cornea is changed continuously without manipulating the cornea.

2. The method of claim 1, wherein the cryoprotectant concentration is increased in 1-3 steps.

3. The method of claim 1, wherein the cryoprotectant concentration is increased continuously in 0-25 min.

4. The method of claim 3, wherein the cryoprotectant concentration is increased continuously to 100% of the target cryoprotectant concentration for vitrification in 8-12 min.

5. The method of claim 3, wherein the cryoprotectant concentration is increased to 100% of the target concentration for vitrification in 5 -15 min.

6. The method of claim 2, wherein the cryoprotectant concentration is increased to 100% of the target cryoprotectant concentration for vitrification in 8-12 min.

7. The method of claim 2, wherein the cryoprotectant concentration is increased to 100% of the target cryoprotectant concentration for vitrification in 5 -15 min.

8. The method of claims 1, further comprising maintaining the cornea in a solution containing said 100% of the target cryoprotectant concentration for vitrification for 10-30 min before vitrification.

9. The method of claim 1, further comprising reducing the concentration of the said cryoprotectant solution surrounding said cornea from 100% of the said target concentration for vitrification to 0% of the said target concentration for vitrification in 0-25 min, wherein said reducing the concentration of the said cryoprotectant solution surrounding said cornea from 100% of the said target concentration for vitrification to 0% of the said target concentration for vitrification is done either continuously or in 1-3 steps.

10. The method of claim 1, wherein the cornea is either manipulated during the method by means of a manipulation means comprising a ring and a suspension means for the ring or the cornea is maintained immobile in the ring of a manipulation means while the concentration of cryoprotectant in contact with the cornea is changed continuously without manipulating the cornea.
